(19) United States
(12) Patent Application Publication
(10) Pub. No.: US 2019/0019448 A1
(43) Pub. Date: Jan. 17, 2019

(54) REDUNDANT MICROLEDS OF MULTIPLE ROWS FOR COMPENSATION OF DEFECTIVE MICROLED

(71) Applicant: Oculus VR, LLC, Menlo Park, CA (US)

(72) Inventor: Ilias Pappas, Cork (IE)

(21) Appl. No.: 16/013,772

(22) Filed: Jun. 20, 2018

Related U.S. Application Data
(60) Provisional application No. 62/531,809, filed on Jul. 12, 2017.

(51) Int. Cl. G09G 3/32; G02B 26/08; F21V 8/00; G02B 27/01

(52) U.S. Cl. CPC G09G 3/32; G02B 26/0833; G02B 6/0035; G02B 27/0172; G09G 2320/0646; G02B 2027/0125; G09G 2320/0285; G02B 2027/0178; G02B 2027/014; G02B 2027/0118; G09G 2330/10

(57) ABSTRACT

Multiple rows of light sources emitting the same color are arranged to provide redundancy against defective light sources. The light sources are used in conjunction with an optical element to display on a screen. Although only a single row of light sources is needed for each color, multiple rows of light sources are provided for each color and the optical element scans vertically across rows to produce an image. When a defective light source is detected, light sources surrounding the defective light source are overdriven to compensate for the defective light source.

### CROSS REFERENCE TO RELATED APPLICATION

This application claims the benefit of U.S. Provisional Application No. 62/531,809, filed Jul. 12, 2017, which is incorporated by reference in its entirety.

### BACKGROUND

This disclosure generally relates to operating light sources to generate images on a screen, and specifically relates to providing redundancy by having more than one rows of light sources.

Light sources may be implemented as one or more rows of microscopic light emitting diodes (microLEDs) that can emit light of a certain color. Generally, microLEDs are formed by processing GaN or GaAs substrates, and tends to have higher total brightness than organic light emitting diode (OLED). Based on the processing of GaN or GaAs substrates, the fabricated microLEDs emit light of different colors. Hence, combinations of microLEDs to form pixels capable of displaying multiple colors.

The process of fabricating microLEDs is complicated and the yield of operable microLEDs may be lower than desired. Hence, one or more microLEDs on asemiconductor backplane may be inoperable or defective, and not emit light.

### SUMMARY

Embodiments of the present disclosure relate to compensating loss of brightness from a light source in an array of light sources by increasing brightness of other light sources. First brightness of light sources in the array of light sources corresponding to the image signal is determined. The first brightness of light sources to second brightness of light sources is adjusted to compensate for a defective light source in the array of light sources. Adjusting the first brightness of light sources to the second brightness of light sources includes increasing the brightness of at least a subset of functioning light sources in a same column as the defective light source, and increasing the brightness of at least a subset of functioning light sources in a same row as the defective light source. The optical element is operated to sequentially reflect light from different rows of the light sources in the array of light sources according to the second brightness onto the scan field.

### BRIEF DESCRIPTION OF THE DRAWINGS

FIG. 1 is a diagram of a near-eye display, in accordance with an embodiment.

FIG. 2 illustrates a cross section of the near-eye display, in accordance with an embodiment.

FIG. 3 illustrates an isometric view of a waveguide display with a single source assembly, in accordance with an embodiment.

FIG. 4 illustrates a cross section of the waveguide display, in accordance with an embodiment.

FIG. 5 is a block diagram of a system including the near-eye display, in accordance with an embodiment.

FIG. 6 is a diagram of a light assembly for an augmented reality display, in accordance with an embodiment.

FIG. 7 is a diagram of a light assembly projecting light onto a scan field, in accordance with an embodiment.

FIG. 8 is a diagram of a scan field of a row of lights from a light assembly over time, in accordance with an embodiment.

FIG. 9 illustrates a flowchart of a process for using a light assembly for a near-eye display, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

Multiple rows of light sources emitting the same color are arranged to provide redundancy against defective light sources. The light sources are used in conjunction with an optical element to display on a screen. Although only a single row of light sources is needed for each color, multiple rows of light sources are provided for each color and the optical element scans vertically across rows to produce an image. When a defective light source is detected, light sources surrounding the defective light source are overdriven to compensate for the defective light source.

In the following description, for the purposes of explanation, specific details are set forth in order to provide a thorough understanding of certain inventive embodiments. However, it will be apparent that various embodiments may be practiced without these specific details. The figures and description are not intended to be restrictive.

This disclosure relates generally to augmented-reality (AR) displays. More specifically, and without limitation, this disclosure relates to optical sources for AR displays. A light assembly comprises multiple rows of light sources per color. The rows are offset from each other for increased resolution.

### System Architecture

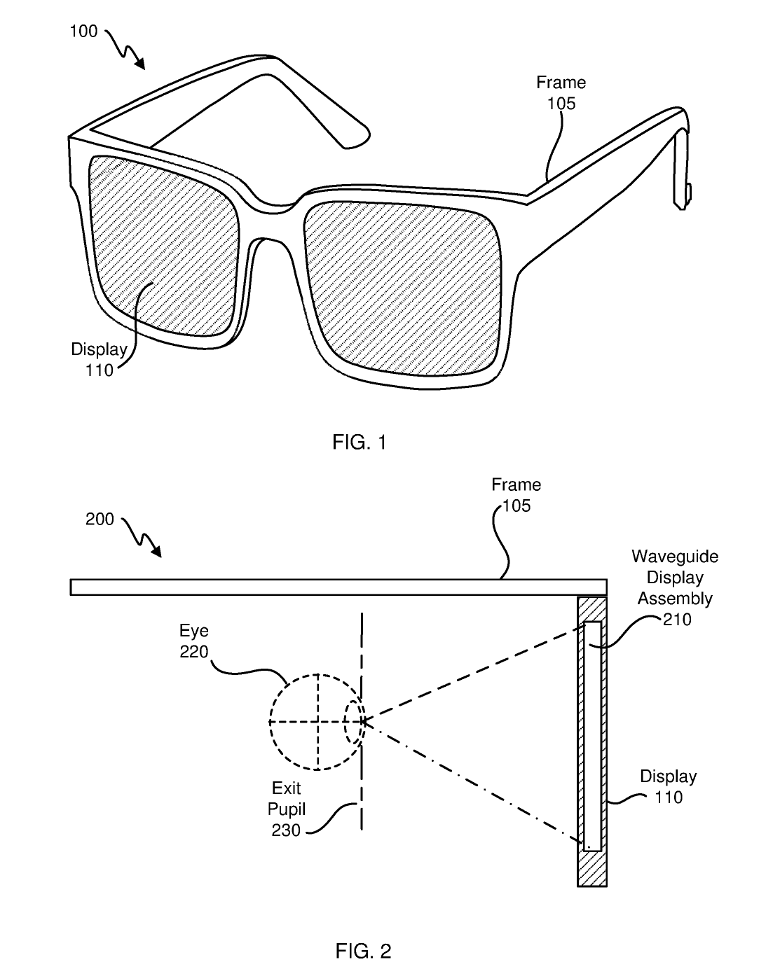

FIG. 1 is a diagram of a near-eye display 100, in accordance with an embodiment. The near-eye display 100 presents media to a user. Examples of media presented by the near-eye display 100 include one or more images, video, and/or audio. In some embodiments, audio is presented via an external device (e.g., speakers and/or headphones) that receives audio information from the near-eye display 100, a console, or both, and presents audio data based on the audio information. The near-eye display 100 is generally configured to operate as a virtual reality (VR) display. In some embodiments, the near-eye display 100 is modified to operate as an augmented reality (AR) display and/or a mixed reality (MR) display.

The near-eye display 100 includes a frame 105 and a display 110. The frame 105 is coupled to one or more optical elements. The display 110 is configured for the user to see content presented by the near-eye display 100. In some embodiments, the display 110 comprises a waveguide display assembly for directing light from one or more images to an eye of the user.

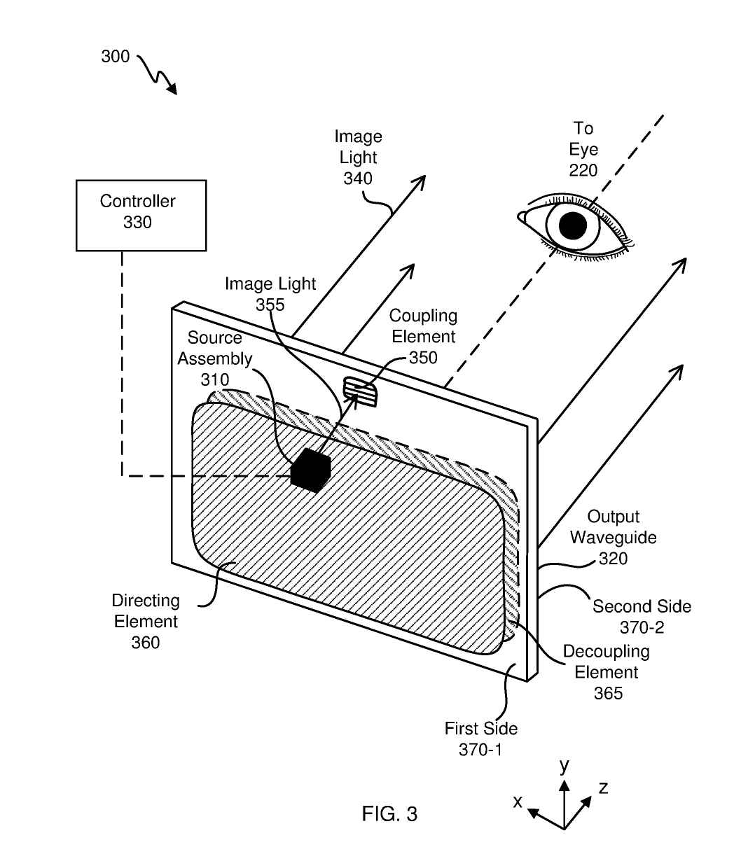

FIG. 2 illustrates a cross section 200 of the near-eye display 100 illustrated in FIG. 1, in accordance with an embodiment. The display 110 includes at least one waveguide display assembly 210. An exit pupil 230 is a location where the eye 220 is positioned in an eyebox region when the user wears the near-eye display 100. For purposes of illustration, FIG. 2 shows the cross section 200 associated with a single eye 220 and a single waveguide display assembly 210, but a second waveguide display is used for a second eye of a user.

The waveguide display assembly 210 is configured to direct image light to an eyebox located at the exit pupil 230 and to the eye 220. The waveguide display assembly 210 may be composed of one or more materials (e.g., plastic, glass, etc.) with one or more refractive indices. In some embodiments, the near-eye display 100 includes one or more optical elements between the waveguide display assembly 210 and the eye 220.

In some embodiments, the waveguide display assembly 210 includes a stack of one or more waveguide displays including, but not restricted to, a stacked waveguide display, a varifocal waveguide display, etc. The stacked waveguide display is a polychromatic display (e.g., a red-green-blue (RGB) display) created by stacking waveguide displays whose respective monochromatic sources are of different colors. The stacked waveguide display is also a polychromatic display that can be projected on multiple planes (e.g. multi-planar colored display). In some configurations, the stacked waveguide display is a monochromatic display that can be projected on multiple planes (e.g. multi-planar monochromatic display). The varifocal waveguide display is a display that can adjust a focal position of image light emitted from the waveguide display. In alternative embodiments, the waveguide display assembly 210 may include the stacked waveguide display and the varifocal waveguide display.

FIG. 3 illustrates an isometric view of a waveguide display 300, in accordance with an embodiment. In some embodiments, the waveguide display 300 is a component (e.g., the waveguide display assembly 210) of the near-eye display 100. In some embodiments, the waveguide display 300 is part of some other near-eye display or other system that directs image light to a particular location.

The waveguide display 300 includes a source assembly 310, an output waveguide 320, and a controller 330. For purposes of illustration, FIG. 3 shows the waveguide display 300 associated with a single eye 220, but in some embodiments, another waveguide display separate, or partially separate, from the waveguide display 300 provides image light to another eye of the user.

The source assembly 310 generates light 355 that form an image on a scan field 700. The source assembly 310 generates and outputs the image light 355 to a coupling element 350 located on a first side 370-1 of the output waveguide 320. The output waveguide 320 is an optical waveguide that outputs expanded image light 340 to an eye 220 of a user. The output waveguide 320 receives the image light 355 at one or more coupling elements 350 located on the first side 370-1 and guides received input image light 355 to a directing element 360. In some embodiments, the coupling element 350 couples the image light 355 from the source assembly 310 into the output waveguide 320. The coupling element 350 may be, e.g., a diffraction grating, a holographic grating, one or more cascaded reflectors, one or more prismatic surface elements, and/or an array of holographic reflectors.

The directing element 360 redirects the received input image light 355 to the decoupling element 365 such that the received input image light 355 is decoupled out of the output waveguide 320 via the decoupling element 365. The directing element 360 is part of, or affixed to, the first side 370-1 of the output waveguide 320. The decoupling element 365 is part of, or affixed to, the second side 370-2 of the output waveguide 320, such that the directing element 360 is opposed to the decoupling element 365. The directing element 360 and/or the decoupling element 365 may be, e.g., a diffraction grating, a holographic grating, one or more cascaded reflectors, one or more prismatic surface elements, and/or an array of holographic reflectors.

The second side 370-2 represents a plane along an x-dimension and a y-dimension. The output waveguide 320 may be composed of one or more materials that facilitate total internal reflection of the image light 355. The output waveguide 320 may be composed of e.g., silicon, plastic, glass, and/or polymers. The output waveguide 320 has a relatively small form factor. For example, the output waveguide 320 may be approximately 50 mm wide along x-dimension, 30 mm long along y-dimension and 0.5-1 mm thick along a z-dimension.

The controller 330 controls scanning operations of the source assembly 310. The controller 330 determines scanning instructions for the source assembly 310. In some embodiments, the output waveguide 320 outputs expanded image light 340 to the user's eye 220 with a large field of view (FOV). For example, the expanded image light 340 provided to the user's eye 220 with a diagonal FOV (in x and y) of 60 degrees and or greater and/or 150 degrees and/or less. The output waveguide 320 is configured to provide an eyebox with a length of 20 mm or greater and/or equal to or less than 50 mm; and/or a width of 10 mm or greater and/or equal to or less than 50 mm.

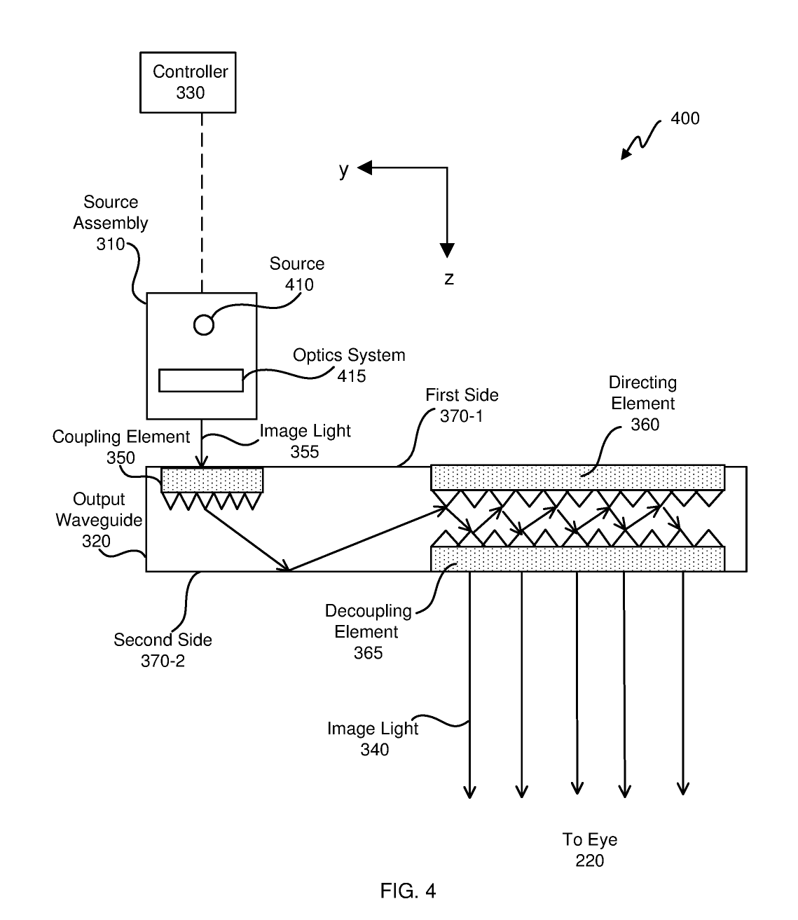

FIG. 4 illustrates a cross section 400 of the waveguide display 300, in accordance with an embodiment. The cross section 400 includes the source assembly 310 and the output waveguide 320. The source assembly 310 generates image light 355 in accordance with scanning instructions from the controller 330. The source assembly 310 includes a source 410 and an optics system 415. The source 410 is a light source that generates coherent or partially coherent light. The source 410 may be, e.g., a laser diode, a vertical cavity surface emitting laser, and/or a light emitting diode.

The optics system 415 includes one or more optical components that condition the light from the source 410. Conditioning light from the source 410 may include, e.g., expanding, collimating, and/or adjusting orientation in accordance with instructions from the controller 330. The one or more optical components may include one or more lens, liquid lens, mirror, aperture, and/or grating. In some embodiments, the optics system 415 includes a liquid lens with a plurality of electrodes that allows scanning a beam of light with a threshold value of scanning angle to shift the beam of light to a region outside the liquid lens. Light emitted from the optics system 415 (and also the source assembly 310) is referred to as image light 355.

The output waveguide 320 receives the image light 355. The coupling element 350 couples the image light 355 from the source assembly 310 into the output waveguide 320. In embodiments where the coupling element 350 is diffraction grating, a pitch of the diffraction grating is chosen such that total internal reflection occurs in the output waveguide 320, and the image light 355 propagates internally in the output waveguide 320 (e.g., by total internal reflection), toward the decoupling element 365.

The directing element 360 redirects the image light 355 toward the decoupling element 365 for decoupling from the output waveguide 320. In embodiments where the directing element 360 is a diffraction grating, the pitch of the diffraction grating is chosen to cause incident image light 355 to exit the output waveguide 320 at angle(s) of inclination relative to a surface of the decoupling element 365.

In some embodiments, the directing element 360 and/or the decoupling element 365 are structurally similar. The expanded image light 340 exiting the output waveguide 320 is expanded along one or more dimensions (e.g., may be elongated along x-dimension). In some embodiments, the waveguide display 300 includes a plurality of source assemblies 310 and a plurality of output waveguides 320. Each of the source assemblies 310 emits a monochromatic image light of a specific band of wavelength corresponding to a primary color (e.g., red, green, or blue). Each of the output waveguides 320 may be stacked together with a distance of separation to output an expanded image light 340 that is multi-colored.

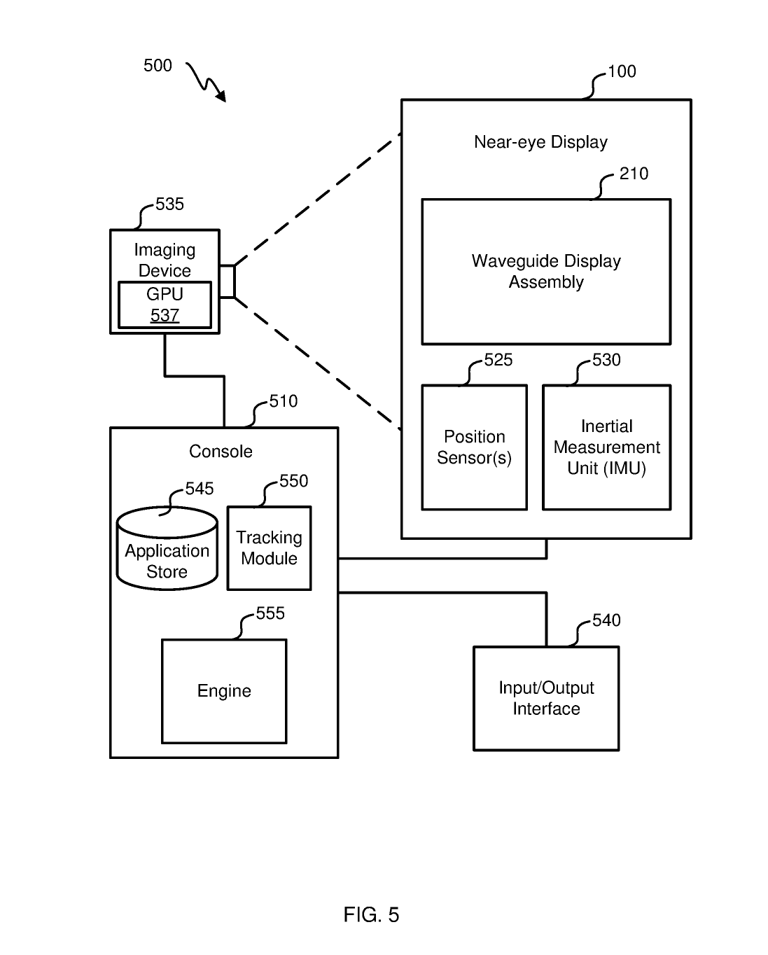

FIG. 5 is a block diagram of a system 500 including the near-eye display 100, in accordance with an embodiment. The system 500 comprises the near-eye display 100, an imaging device 535, and an input/output interface 540 that are each coupled to a console 510.

The near-eye display 100 is a display that presents media to a user. Examples of media presented by the near-eye display 100 include one or more images, video, and/or audio. In some embodiments, audio is presented via an external device (e.g., speakers and/or headphones) that receives audio information from the near-eye display 100 and/or the console 510 and presents audio data based on the audio information to a user. In some embodiments, the near-eye display 100 may also act as an AR eyewear glass. In some embodiments, the near-eye display 100 augments views of a physical, real-world environment, with computer-generated elements (e.g., images, video, sound, etc.).

The near-eye display 100 includes a waveguide display assembly 210, one or more position sensors 525, and/or an inertial measurement unit (IMU) 530. The waveguide display assembly 210 includes the source assembly 310, the output waveguide 320, and the controller 330.

The IMU 530 is an electronic device that generates fast calibration data indicating an estimated position of the near-eye display 100 relative to an initial position of the near-eye display 100 based on measurement signals received from one or more of the position sensors 525.

The input/output interface 540 is a device that allows a user to send action requests to the console 510. An action request is a request to perform a particular action. For example, an action request may be to start or end an application or to perform a particular action within the application.

The console 510 provides media to the near-eye display 100 for presentation to the user in accordance with information received from one or more of: the imaging device 535, the near-eye display 100, and the input/output interface 540. In the example shown in FIG. 5, the console 510 includes an application store 545, a tracking module 550, and an engine 555.

The application store 545 stores one or more applications for execution by the console 510. An application is a group of instructions, that when executed by a processor, generates content for presentation to the user. Examples of applications include: gaming applications, conferencing applications, video playback application, or other suitable applications.

The tracking module 550 calibrates the system 500 using one or more calibration parameters and may adjust one or more calibration parameters to reduce error in determination of the position of the near-eye display 100.

The tracking module 550 tracks movements of the near-eye display 100 using slow calibration information from the imaging device 535. The tracking module 550 also determines positions of a reference point of the near-eye display 100 using position information from the fast calibration information.

The engine 555 executes applications within the system 500 and receives position information, acceleration information, velocity information, and/or predicted future positions of the near-eye display 100 from the tracking module 550. In some embodiments, information received by the engine 555 may be used for producing a signal (e.g., display instructions) to the waveguide display assembly 210 that determines a type of content presented to the user.

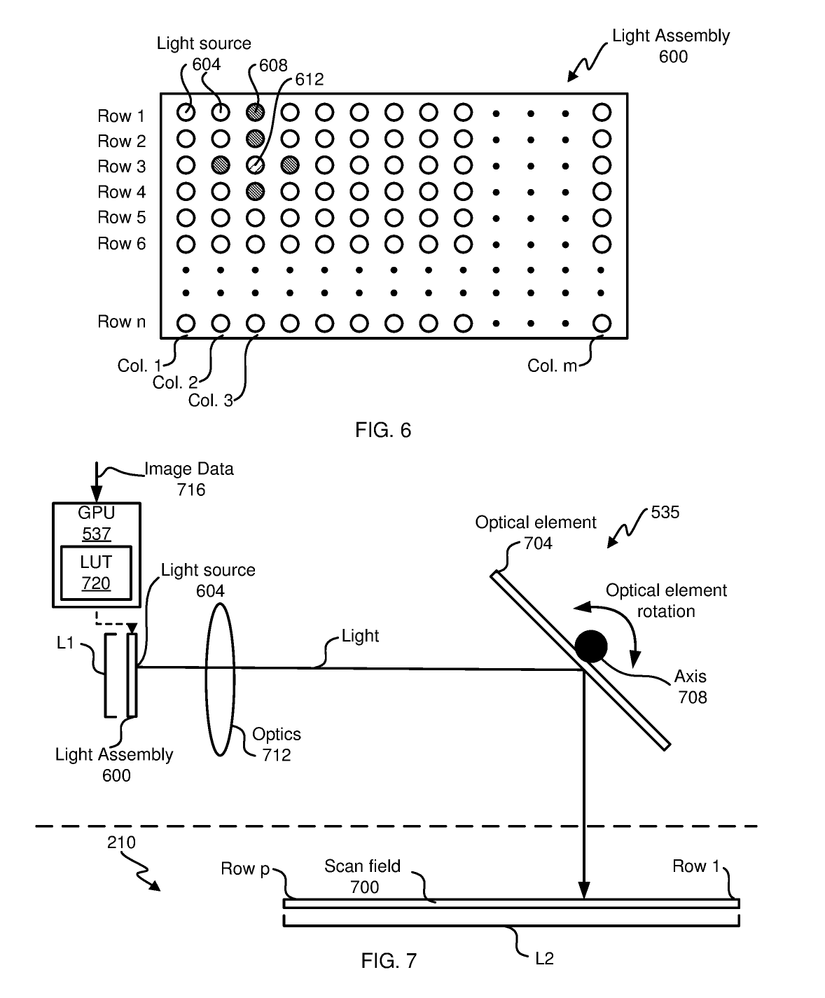

FIG. 6 is a diagram of a light assembly 600 for an AR display, according to one embodiment. The light assembly 600 includes a plurality of light sources 604. Light sources 604 emit light of a particular color or wavelength band. In some embodiments, the light source 604 is a laser or a light emitting diode (LED) (e.g., a micro LED). The light sources 604 are arranged in rows and columns. Shown in FIG. 6 are row 1, row 2, row 3, row 4, row 5, row 6 to row n; column 1, column 2, column 3, to column m of the light assembly 600. A column of the array of light sources 604 includes a first set of light sources emitting a first color, a second set of light sources emitting a second color, and a third set of light source emitting a third color. In some embodiments, twelve rows are used in the light assembly 600; four rows of light sources 604 have red LEDs, four rows of light sources 604 have green LEDs, and four rows of light sources 604 have blue LEDs. In some embodiments, 3 to 7 rows of light sources 604 are used for one color in the light assembly 600. Light sources 604 emit light in a circular pattern, which can be useful when phasing light sources 604 of one row with another row.

Light sources 604 may include a defective light source 612. The defective light source 612 is a light source 604 with faulty operation (e.g., emit light of low brightness or does not turn on). The defective light source 612 may be determined during an inspection stage of the array of light sources 604. In some embodiments, two or more defective light sources are present in the array of light sources 604.

The brightness of a subset of light sources 604 is increased to compensate for the defective light source 612 in the array of light sources 604. The subset of light sources 604 include light sources 604 in a same column (e.g., col. 3) as the defective light source 612, and adjacent light sources 604 (left and right light sources) in a same row (e.g., row 3) as the defective light source 612. The subset of light sources 604 only include ones that emit the same color of light as the defective light source 612. For example, the at least subset 608 of functioning light sources 604 in column 3 emit red color and the defective light source 612 is supposed to emit red color if it functions properly.

FIG. 7 is a diagram illustrated light from a light assembly 600 projected onto a scan field 700, in accordance with an embodiment. The imaging device 535 may include, among other components, the GPU 537, a light assembly 600, a light source 604, optics 712, and an optical element 704. Although only one ray of light is illustrated in FIG. 7, multiple rays of light corresponding to columns of the light sources 612 are emitted from the light assembly 600.

The GPU 537 receives image data 716 representing an image to be reproduced on a scan field 700 and determines a first brightness of light sources 604 in an array of light sources 604 corresponding to the image data 716. The GPU 537 includes a look-up table (LUT) 720. The LUT 720 stores adjustment parameters for adjusting the first brightness of the array of light sources 604 to the second brightness of the array of light sources 604. The adjustment parameters may be determined during an inspection stage of the array of light sources 604. The GPU 537 adjusts the first brightness of light sources 604 to second brightness of light sources 604 to compensate for a defective light source in the array of light sources 604 by increasing brightness of at least a subset of functioning light sources 604 in a same column as the defective light source, and increasing brightness of at least a subset of functioning light sources 604 in a same row as the defective light source. The GPU 537 adjusts the first brightness of the array of light sources 604 to the second brightness of the array of light sources 604 in accordance with the adjustment parameters stored in the look-up table 720. For example, the at least subset 608 of functioning light sources 604 is increased in brightness by 35 percent to compensate for the defective light source 612.

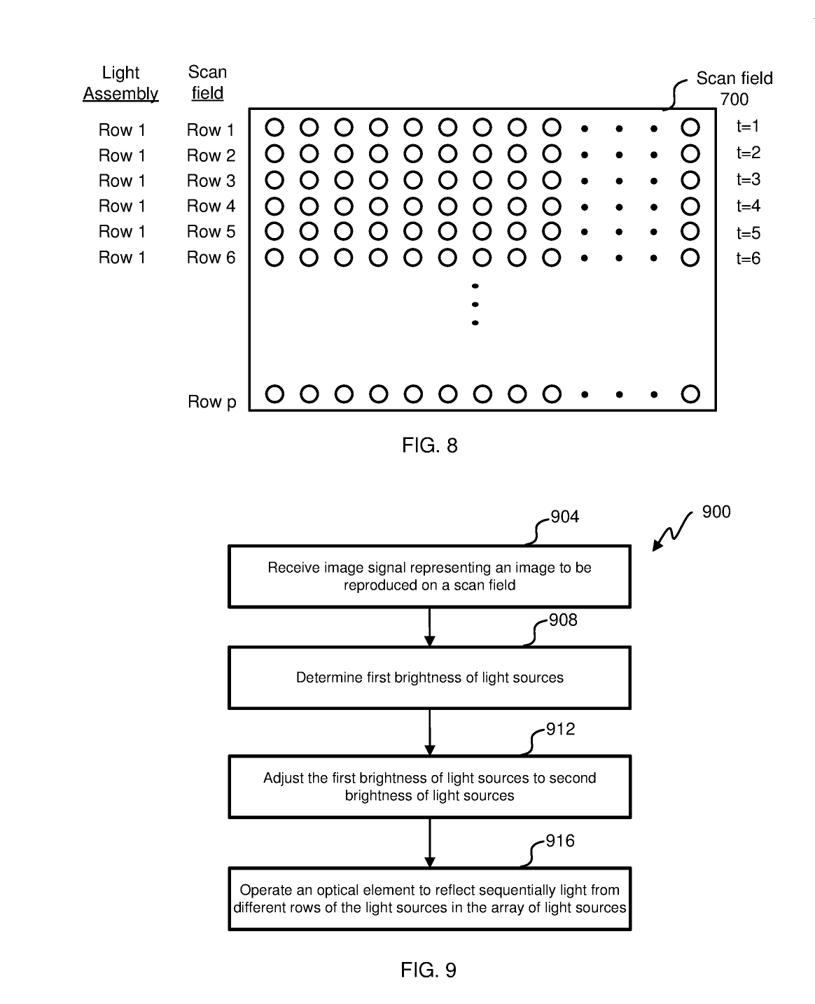

Light from light sources 604 is transmitted from the light assembly 600 to an optical element 704, and from the optical element 704 to the scan field 700 (shown in FIG. 8). The optical element 704 rotates about an axis 708. As the optical element 704 rotates, light from a row of light sources 604 is directed to a different part of the scan field 700. Optics 712 are used to collimate and/or focus light from the light assembly 600 to the optical element 704 and/or to the scan field 700.

The waveguide display assembly 210 includes the scan field 700. As shown in FIG. 8, the scan field 700 is divided into pixel locations divided into rows and columns. The scan field 700 has row 1 to row p and column 1 to column q. Referring back to FIG. 7, the light assembly 600 has a first length L1, which is measured from row 1 to row n of the light assembly 600. The scan field 700 has a second length L2, which is measured from row 1 to row p of the scan field 700. L2 is greater than L1 (e.g., L2 is 50 to 10,000 times greater than L1).

The optical element 704 can rotate in two dimensions. For example, the number of columns m of the light assembly 600 can be less than the number of columns q of the scan field 700. The optical element 704 rotates in two dimensions to fill the scan field 700 with light from the light assembly 600 (e.g., a raster-type scanning down rows then moving to new columns in the scan field 700). The optical element 704 is operated to reflect sequentially light from different rows of the light sources in the array of light sources according to the second brightness onto the scan field 700. In some embodiments, the optical element 704 is a waveguide or a micro-mirror.

FIG. 8 is a diagram of a scan field 700 of a row of lights from a light assembly over time, in accordance with an embodiment. In the embodiment of FIG. 8, the physical distance of the light sources of the light assembly is equal to the pitch of a pixel location of the scan field 700. As the optical element 704 rotates in time, row 1 of the light assembly 600 aligns with different rows of the scan field 700. For example, at time t=1, row 1 of the light assembly 600 aligns with row 1 of the scan field 700; at time t=2, row 1 of the light assembly 600 aligns with row 2 of the scan field 700; at time t=3, row 1 of the light assembly 600 aligns with row 3 of the scan field 700; at time t=4, row 1 of the light assembly 600 aligns with row 4 of the scan field 700; at time t=5, row 1 of the light assembly 600 aligns with row 5 of the scan field 700; at time t=6, row 1 of the light assembly 600 aligns with row 6 of the scan field 700; and so on until row 1 aligns with row P of the scan field 700. As light from row 1 of the light assembly 600 is scanned across the scan field 700 by the mirror 704, an image is formed in the scan field 700.

In some embodiments, the physical distance of the light sources of the light assembly is n times (where n is an integer larger than 1) the pitch of the display pixel, and, as a result, the scan field 700 is delayed by one time. For example, at time t=1, row 1 of the light assembly 600 does not align with a row of the scan field 700; at time t=2, row 1 of the light assembly 600 aligns with row 1 of the scan field 700; at time t=3, row 1 of the light assembly 600 aligns with row 2 of the scan field 700; at time t=4, row 1 of the light assembly 600 aligns with row 3 of the scan field 700; at time t=5, row 1 of the light assembly 600 aligns with row 4 of the scan field 700; at time t=6, row 1 of the light assembly 600 aligns with row 5 of the scan field 700.

### Example Method for Compensating Defective Light Source

FIG. 9 illustrates a flowchart of a process for using a light assembly for a near-eye display, in accordance with an embodiment.

A GPU receives 904 an image signal representing an image to be reproduced on a scan field. In some embodiments, the GPU is part of an imaging device and receives the image signal from a console.

The GPU determines 908 first brightness of light sources in an array of light sources corresponding to the image signal.

The GPU adjusts 912 the first brightness of light sources to second brightness of light sources to compensate for a defective light source in the array of light source by increasing brightness of at least a subset of functioning light sources in a same column as the defective light source, and increasing brightness of at least a subset of functioning light sources in a same row as the defective light source. The GPU 537 includes a look-up table (LUT) that stores adjustment parameters for adjusting the first brightness of the array of light sources to the second brightness of the array of light sources.

The optical element is operated 916 to reflect sequentially light from different rows of the light sources in the array of light sources according to the second brightness onto the scan field.

The language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving image signal representing an image to be reproduced on a scan field;
determining first brightness of light sources in an array of light sources corresponding to the image signal;
adjusting the first brightness of light sources to second brightness of light sources to compensate for a defective light source in the array of light source by:
increasing brightness of at least a subset of functioning light sources in a same column as the defective light source, and increasing brightness of at least a subset of functioning light sources in a same row as the defective light source; and
operating an optical element to reflect sequentially light from different rows of the light sources in the array of light sources according to the second brightness onto the scan field.

2. The method of claim 1, wherein the at least subset of functioning light sources in the same row consists of light sources at an immediate left side and an immediate right side of the defective light source on the same row.

3. The method of claim 1, wherein the at least subset of functioning light sources in the same column consists of light sources arranged to emit same color of light as the defective light sources.

4. The method of claim 3, where a column of the array of light sources comprises a first set of light sources emitting a first color, a second set of light sources emitting a second color, and a third set of light source emitting a third color.

5. The method of claim 1, further comprising storing in a look-up table, for each light source in the array of light sources, adjustment parameters for adjusting the first brightness of the array of light sources to the second brightness of the array of light sources.

6. The method of claim 5, wherein the adjustment parameters are determined during an inspection stage of the array of light sources.

7. The method of claim 5, wherein the look-up table is stored in a Graphics Processing Unit.

8. The method of claim 1, wherein the optical element is a waveguide or a micro-mirror.

9. The method of claim 1, wherein the light sources are light emitting diodes (LEDs).

10. An apparatus comprising:
a processor configured to:
receive image signal representing an image to be reproduced on a scan field,
determine first brightness of light sources in an array of light sources corresponding to the image signal,
adjust the first brightness of light sources to second brightness of light sources to compensate for a defective light source in the array of light source by:
increasing brightness of at least a subset of functioning light sources in a same column as the defective light source, and
increasing brightness of at least a subset of functioning light sources in a same row as the defective light source; and
an optical element operated to sequentially reflect light from different rows of the light sources in the array of light sources according to the second brightness onto the scan field.

11. The apparatus of claim 10, wherein the at least subset of functioning light sources in the same row consists of light sources at an immediate left side and an immediate right side of the defective light source on the same row.

12. The apparatus of claim 10, wherein the at least subset of functioning light sources in the same column consists of light sources arranged to emit same color of light as the defective light sources.

13. The apparatus of claim 12, where a column of the array of light sources comprises a first set of light sources emitting a first color, a second set of light sources emitting a second color, and a third set of light source emitting a third color.

14. The apparatus of claim 10, wherein the processor is further configured to store in a look-up table, for each light source in the array of light sources, adjustment parameters for adjusting the first brightness of the array of light sources to the second brightness of the array of light sources.

15. The apparatus of claim 14, wherein the adjustment parameters are determined during an inspection stage of the array of light sources.

16. The apparatus of claim 14, wherein the look-up table is stored in a Graphics Processing Unit.

17. The apparatus of claim 10, wherein the optical element is a waveguide or a micro-mirror.

18. The apparatus of claim 10, wherein the light sources are light emitting diodes (LEDs).
